(19) United States
(12) Patent Application Publication
(10) Pub. No.: US 2021/0240141 A1
(43) Pub. Date: Aug. 5, 2021

(54) CONDUCTIVE BALANCE-SPRING CORD

(71) Applicant: ETA SA MANUFACTURE HORLOGÈRE SUISSE, Grenchen (CH)

(72) Inventor: Sylvain HUOT-MARCHAND, Eschert (CH)

(73) Assignee: ETA SA MANUFACTURE HORLOGÈRE SUISSE, Grenchen (CH)

(21) Appl. No.: 17/146,793

(22) Filed: Jan. 12, 2021

(30) Foreign Application Priority Data
Jan. 30, 2020 (EP) 20154530.8

(51) Int. Cl. G04D 3/00; H05F 3/00; B05D 1/02

(52) U.S. Cl. CPC G04D 3/0089; B05D 1/02; H05F 3/00

(57) ABSTRACT

A deposition method (500) of an electroconductive layer electrically connecting at least one outer coil (105) and a balance-spring stud (102) and representing at least 1%, particularly 5%, preferably 10% and/or at most 90%, particularly at most 75%, preferably at most 50% of at least one dimension of a horological balance-spring (101).

### CROSS-REFERENCE TO RELATED APPLICATIONS

This application claims priority to European Patent Application No. 20154530.8 filed Jan. 30, 2020, the entire contents of which are incorporated herein by reference.

### TECHNICAL FIELD

The present invention relates to an oscillating system for a horological movement. The present invention particularly relates to an oscillating system comprising a horological balance-spring from which the electrostatic charges can be removed.

### TECHNOLOGICAL BACKGROUND

Balance-springs which form with the balance the time base for mechanical timepieces are known in the field of watchmaking. These balance-springs are presented schematically in the form of a very thin spring wound into concentric coils and wherein a first end is connected to a collet and wherein a second end is connected to a balance-spring stud.

The material used for producing balance-springs is usually an alloy based on iron, cobalt, nickel, and chromium. Ductile, such an alloy must be corrosion-proof. Recent developments propose producing balance-springs made of silicon. Due to the very small dimensions thereof and frictions with air and between the coils, balance-springs tend to be charged with static electricity, such that the coils stick to one another. The coils are then unusable as such.

Moreover, current methods aiming to discharge the electrostatic charges in the movement via the balance-spring stud involve an electroconductive glue binding the balance-spring stud and the balance-spring. It is generally the mixture of a photo- or UV-setting glue and conductive particles. However, these particles impede the crosslinking of the assembly. This can result in partial crosslinking and therefore stud-balance-spring separation, which impedes the operation of the oscillator. A further solution is that of significantly increasing the crosslinking time but this goes counter to industrial production rates.

Finally, in some cases, the electrostatic charges can be located elsewhere than on the balance-spring but in the close environment thereof, for example a component made of insulating material initially charged during assembly or charged during a movement. These charges, generally associated with a significantly larger element than the balance-spring, will therefore attract the balance-spring and cause malfunctions by introducing stress therein and therefore a modification of the natural frequency thereof.

To remedy these problems, more or less complex solutions suggesting for example performing on all or part of the surface of the balance-springs a light deposition of a material, preferably non-oxidising and non-magnetic, such as gold, platinum, rhodium, or silicon have been proposed. Such techniques require, however, additional manufacturing steps which have particularly the drawback of being costly. Furthermore, these techniques tend to slow down production rates. To remedy these drawbacks, the present invention proposes an oscillating system for a horological movement comprising a horological balance-spring from which the electrostatic charges can be removed.

### SUMMARY OF THE INVENTION

To remedy these drawbacks, the present invention proposes a method for depositing an electroconductive layer on an oscillating system of a horological movement comprising a horological balance-spring with at least one coil attached with a balance-spring stud, said deposition method comprising a step of:
Providing said oscillating system; and/or
Depositing at least a first electroconductive layer electrically connecting said at least one outer coil and said balance-spring stud and representing at least 1%, particularly 5%, preferably 10% and/or at most 90%, particularly at most 75%, preferably at most 50% of at least one dimension of said horological balance-spring.

Thanks to this arrangement, an oscillating system for a horological movement comprising a horological balance-spring from which the electrostatic charges can be removed.

According to an embodiment said horological balance-spring comprises at least one inner coil attached by a collet and at least one outer coil attached by said balance-spring stud.

According to an embodiment, said at least a first electroconductive layer is deposited on the outside of said balance-spring stud.

Thanks to this arrangement, said at least a first electroconductive layer can be readily deposited.

According to an embodiment, the deposition of said first electroconductive layer is carried out by an atomiser.

According to an embodiment, said atomiser comprises at least a first electroconductive layer in liquid form surrounded by a sheathing gas so as to be unidirectional.

According to an embodiment, said atomiser is unidirectional.

According to an embodiment, said first electroconductive layer comprises a continuous electroconductive layer and/or a plurality of discrete electroconductive layers so as to form a continuous electroconductive layer.

Thanks to one or the other of these preceding arrangements, a continuous electroconductive layer and/or a plurality of discrete electroconductive layers can be deposited in a targeted, i.e., unidirectional, manner.

According to an embodiment, said at least one dimension is the length of said horological balance-spring.

Thanks to this arrangement, an oscillating system for a horological movement comprising a horological balance-spring from which the electrostatic charges can be removed.

### BRIEF DESCRIPTION OF THE FIGURE

The invention will be described hereinafter in more detail using the appended drawing, given by way of non-limiting example, represents a deposition method (500) of an electroconductive layer on an oscillating system (100) of a horological movement.

### DETAILED DESCRIPTION OF THE INVENTION

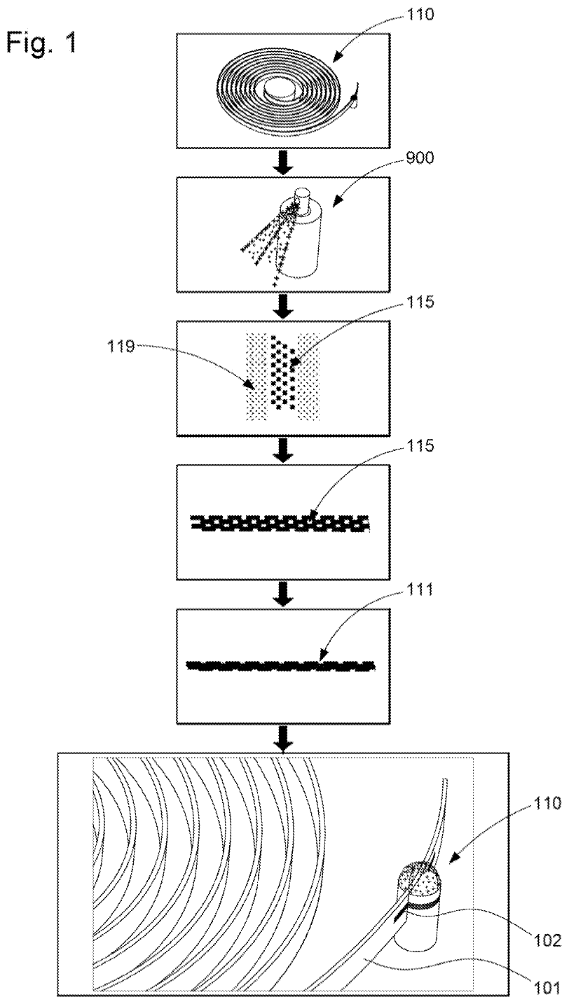

FIG. 1 illustrates a deposition method 500 of an electroconductive layer on an oscillating system 100 of a horological movement comprising a horological balance-spring 101 with at least one internal coil attached by a collet and at least one outer coil 105 attached by a balance-spring stud 102.

One of the steps of said deposition method 500 is that of providing 510 said oscillating system 100. This is followed by depositing at least a first electroconductive layer 110 by an atomiser 900 electrically connecting said at least one outer coil 105 and said balance-spring stud 102. Preferably, said first electroconductive layer 110 comprises a continuous electroconductive layer 111 and/or a plurality of discrete electroconductive layers 115 so as to form a continuous electroconductive layer 111.

Said at least a first electroconductive layer 110, more specifically, said continuous electroconductive layer 111 is deposited and/or said plurality of discrete electroconductive layers 115 are deposited on the outside of said balance-spring stud 102, more precisely on the part of said balance-spring stud 102 being outside said horological balance-spring 101 as it is more readily attainable than the part facing the coils of said horological balance-spring 101.

Said atomiser 900 is configured to deposit said at least a first electroconductive layer 110 in liquid form surrounded by a sheathing gas 119 so as to be unidirectional and therefore deposit said first electroconductive layer 110 on said at least one dimension, preferably the length of said horological balance-spring 101, and representing at least 1%, particularly 5%, preferably 10% and/or at most 90%, particularly at most 75%, preferably at most 50% of at least one dimension of said horological balance-spring 101. Moreover, said atomiser 900 being unidirectional the deposition of said at least a first electroconductive layer 110 can only partially cover the width of said horological balance-spring 101 but possibly not the entire width of said horological balance-spring 101 which makes it possible to avoid a change of characteristic of said horological balance-spring 101 such as for example the inertia thereof or the frequency thereof, or a modification of the elastic response thereof.

Thus, thanks to this arrangement, the conduction of the electrical charges is enabled by depositing said at least a first electroconductive layer 110 on the surface thereof.

Moreover, the deposition method is economical due to the simplicity thereof, and the small amount of material deposited. Furthermore, unlike a glue charged with silver or carbon nanoparticles, for example, this deposition method does not expose employees to potentially hazardous particles during said preparation of these glues or during the deposition due to the inhalation thereof as the spraying is rarely directional or unidirectional. A further disadvantage of conventional spraying is that it can pollute nearby mobile components such as the escapement or the staff of the balance and therefore disturb the tribological functions thereof.

1. A deposition method of an electroconductive layer on an oscillating system of a horological movement comprising a horological balance-spring with at least one internal coil attached by a collet; said deposition method comprising a step of:
providing said oscillating system; and
depositing at least a first electroconductive layer carried out by an atomiser (900) electrically connecting said at least one outer coil and said balance-spring stud and representing at least 1% of at least one dimension of said horological balance-spring,
wherein said atomiser comprises at least a first electroconductive layer in liquid form surrounded by a sheathing gas so as to be unidirectional.

2. The deposition method according to claim 1, wherein said at least a first electroconductive layer is deposited on the outside of said balance-spring stud.

3. The deposition method according to claim 1, wherein said atomiser is unidirectional.

4. The deposition method according to claim 1, wherein said first electroconductive layer comprises a continuous electroconductive layer and/or a plurality of discrete electroconductive layers so as to form a continuous electroconductive layer.

5. The deposition method according to claim 1, wherein said at least one dimension is the length of said horological balance-spring.

6. The deposition method according to claim 1, wherein the first electroconductive layer represents 5% of at least one dimension of said horological balance-spring.

7. The deposition method according to claim 1, wherein the first electroconductive layer represents 10% of at least one dimension of said horological balance-spring.

8. The deposition method according to claim 1, wherein the first electroconductive layer represents at most 90% of at least one dimension of said horological balance-spring.

9. The deposition method according to claim 1, wherein the first electroconductive layer represents at most 75% of at least one dimension of said horological balance-spring.

10. The deposition method according to claim 1, wherein the first electroconductive layer represents at most 50% of at least one dimension of said horological balance-spring.

11. The deposition method according to claim 1, wherein the first electroconductive layer represents at least 1% and at most 90% of at least one dimension of said horological balance-spring.
